(19) United States
(12) Patent Application Publication
(10) Pub. No.: US 2007/0228687 A1
(43) Pub. Date: Oct. 4, 2007

(54) Bicycle propulsion mechanism

(76) Inventor: Rodger Parker, Camarillo, CA (US)

Correspondence Address: MARC E. HANKIN, ESQ., 11414 THURSTON CIRCLE, LOS ANGELES, CA, 90049, US

(21) Appl. No.: 11/378,749

(22) Filed: Mar. 17, 2006

(51) Int. Cl. B62M 1/04

(52) U.S. Cl. 280/252; 280/253

(57) ABSTRACT

This invention discloses a mechanism for propelling a bicycle through rectilinear reciprocation of the pedals. The mechanism includes a crank lever, which when forced by the drivers legs, pushes a drive arm that, in turn, rotates a drive wheel. The rotation of the drive wheel transmits a torque to the bicycles rear wheel via a gearing mechanism. A guide lever meanwhile maintains the proper position of the crank lever throughout its reciprocating cycle.

### FIELD OF INVENTION

This invention relates, generally, to propulsion mechanisms for bicycles; more particularly to propulsion mechanisms for bicycles that propel the bicycle wheels by rectilinear reciprocation of the pedals.

### BACKGROUND

Conventional bicycles use a common propulsion mechanism consisting of pedal on a crank driving a round crank gear that is connected to sprockets by a chain that drives the rear wheel of the bike. While this common mechanism has been generally successful, many efforts have been made to improve upon the ergonomics and efficiency of the mechanism. Specifically, improvements have been directed towards improving shortcomings which arise from circular motion of the pedals because the drive is only able to produce maximum power during the time in which the rider's tibia is perpendicular to the crank. That is, because torque is maximized when the direction of the foot's force and the direction of the crank are perpendicular, maximum torque is only achieved once per crank revolution on a conventional bicycle. Thus, improvements have sought to allow the rider to power the bicycle with a crank mechanism that remains perpendicular to the rider's tibia and uses a longer crank, in order to maximize torque through rectilinear reciprocation.

An example of one such device is disclosed by U.S. Pat. No. 1,505,271 to McNeil, which teaches a bicycle that utilizes long cranks, whose fulcrum is at the portion of the bicycle frame extending behind the rear wheels, to drive a crank gear located behind the rear hub of the bicycle. The crank gear is connected to the rear sprocket by a chain. While this mechanism allows rectilinear reciprocation, it does so at the expense of adding numerous mechanical parts, an unusual bicycle frame extension, and a crank and chain mechanism; all of which add weight and complications to the propulsion mechanism.

Another variation on a rectilinear reciprocating mechanism is disclosed by U.S. Pat. No. 1,427,589 to Greenison. Greenison's mechanism uses crank levers located behind the rear hub of the bicycle to drive a crank gear also located behind the rear hub. The crank gear, in turn, drives the rear sprocket by a chain connecting the two. Unlike McNeil's mechanism, the fulcrum in Greenison's mechanism is between the rear hub and the crank gear. Nevertheless, this mechanism suffers from many of the same shortcomings, including numerous mechanical parts, a large and unusual bicycle frame, and the use of a chain to drive the rear sprocket.

Another, yet even more elaborate, mechanism is disclosed by U.S. Pat. No. 2,169,110 to Woerner. Woerner teaches a chainless bicycle mechanism that achieves rectilinear reciprocating motion by connecting the crank lever to a pitman arm that drives the rear hub. The crank, in Woerner's configuration, consists of a triangle that pivots from a point in the bicycle frame above and behind the rear hub of the bicycle. Woerner, thus, relies upon many undesirable additional parts to facilitate the drive mechanism. What is more, the device fails to disclose a mechanism that can operate with multiple gear ratios, which are often desirable in bicycle drives.

Another chainless bicycle that also uses numerous mechanical parts to achieve rectilinear reciprocation is disclosed by U.S. Pat. No. 4,053,173 to Chase, Sr. Chase, Sr. teaches a mechanism utilizing a crank lever whose fulcrum lies at the base of the bicycle frame, immediately in front of the rear wheel. The motion of the crank lever drives a first pitman arm, which connects to an L-shaped lever that drives a second pitman arm connected to the rear hub's sprockets. Like the above mechanisms, Chase, Sr.'s device similarly relies upon a system with many, undesirable mechanical parts and an unconventional frame design to achieve reciprocating rectilinear motion.

Another bicycle power system, in the same vein as McNeil and Greenison above, is disclosed by U.S. Pat. No. 4,561,318 to Schirrmacher. Schirrmacher's mechanism also relies upon long cranks whose fulcrum lies behind the rear hub to drive a system of chains, gears, and levers that drive the rear sprocket of the bicycle. The complex mechanical power drive disclosed by Schirrmacher makes it an undesirable means of achieving reciprocating rectilinear motion.

A chainless power drive for bicycles is taught by U.S. Pat. No. 5,002,296 to Chiu. While Chiu does not teach a means for reciprocating rectilinear motion, Chiu's mechanism eliminates the conventional bicycle chain and replaces it with two gears, which connect the crank gear to the rear hub sprocket.

The device taught by Mannino in U.S. Pat. No. 5,172,926 is a power drive mechanism for bicycles wherein the pedals move in a D-shaped pattern, rather than in the circular manner of conventional bicycles. This D-shaped pattern seeks to increase the force produced by the rider's motion, avoid “dead spots” associated with conventional bicycle mechanisms, and improve upon the torque transmitted to the rear wheels. Mannino's mechanism utilizes a crank gear located in the same position as in a conventional bicycle to drive the rear sprocket by a chain. Unlike a conventional mechanism, the crank lever is connected to the crank gear by a lever arm. The lever arm travels on a circular path while the crank gear is configured to follow a D-shaped path. The distal end of the crank lever (that is, the end not attaching the pedal), is connected to a guide lever connected to the bicycle frame, which ensures that the crank levers remain constantly in motion. While Mannino's device makes many improvements upon the conventional bicycle mechanism, it continues to rely upon a conventional bicycle's gear and chain drive. Also, the additional parts used by Manniono, the lever arm and guide lever, add further undesirable complexity and moving parts to the conventional bicycle mechanism.

Reciprocating rectilinear motion using a system of levers, gears, and chains is taught by U.S. Pat. No. 5,242,182 to Bezerra et al. Bezerra's mechanism relies upon crank levers whose fulcrum lies at the base of the bicycle frame. The motion of the crank levers pushes connecting rods that drive a number of gears located on an extension to the bicycle frame above the rear wheel. The gears keep the crank levers moving in opposite directions and connect to a chain that connects to the rear sprocket of the bicycle. This mechanism, like those described above, includes many undesirable elements, such as multiple gears and chains.

U.S. Pat. No. 5,690,345 to Kiser teaches a mechanism for moving a bicycle lever in a rectilinear path. Kiser's mechanism is located in the position as the crank gear of a conventional bicycle. The mechanism, however, employs an elaborate system of chains, gears, sprockets, and levers in order to achieve rectilinear motion. As such, the mechanism is undesirable to bicyclists for whom simplicity, reliability, and lightness are advantageous.

A lever driven bicycle that uses a system of linkages in an accordion configuration is disclosed by U.S. Pat. No. 5,988,662 to Staehlin. Staehlin's device uses pedals connected to an accordion shaped linkage system that drives the crank lever whose power is transmitted to the rear wheels. Like the above patents, Staehlin's propulsion mechanism uses numerous moving parts and a complex mechanism that is undesirable to bicycle riders.

U.S. Pat. No. 6,595,535 to Farina discloses a novel bicycle, which utilizes an unconventional power drive. In Farina's device, crank levers located adjacent to the rear wheel of the bicycle attach to a fulcrum located above the rear wheel. The crank levers drive a crank gear, located above the rear wheel, which is connected to the rear sprocket by a chain running vertically upwards and downwards. Farina's device improves upon some features of of the conventional bicycle while remaining limited because of the many moving parts that it utilizes.

U.S. Pat. Nos. 6,349,956 and 6,478,322, both to Fujiwara et al., and U.S. Patent Application No. 2001/0048209, also to Fujiwara, disclose a rectilinear reciprocating power drive which is an improvement upon the conventional bicycle mechanism. In 2001/0048209 Fujiwara discloses a system utilizing a long crank lever whose fulcrum lies behind the rear hub and is kept rotating and in proper position by a gear located immediately in front of the rear hub. In U.S. Pat. Nos. 6,349,956 and 6,478,322, Fujiwara teaches a mechanism similar to Mannino above, whereby the crank lever attaches to a lever that drives the crank gear. Unlike Mannino, however, Fujiwara's guide lever connects slidably to the lower arm of the rear triangle of the bicycle frame. Fujiwara, thus, teaches many improvements on the above mechanism to achieve reciprocating rectilinear motion of the bicycle pedals. However, Fujiwara's mechanisms remain complex and, thus, undesirable to many bicycle users.

Thus, there is a long-felt need in the art for a rectilinear reciprocating propulsion mechanism that uses crank levers, which lie generally perpendicular to the rider's tibia, uses longer cranks than a conventional bicycle, allowing greater torque, and uses a mechanism with relatively few parts in order to generate greater power than a conventional bicycle power drive.

### SUMMARY OF THE INVENTION

This invention is directed towards overcoming the above shortcomings by disclosing a bicycle propulsion mechanism whose pedals move in a rectilinear reciprocating pattern, whose crank levers are much longer than those of a conventional bicycle, provide excellent ergonomics, makes a highly efficient use of the power transmitted by the rider, and which uses relatively few parts for a smooth, reliable, and highly adaptable mechanism.

This invention is used on a modified version of a conventional bicycle frame. By eliminating many of the parts needed for conventional bicycle propulsion and frames, this invention offers the advantage of saving a great deal of weight. Meanwhile, by providing an efficient, lightweight, and relatively simple means of achieving rectilinear reciprocating pedal motion, the invention offers a substantial improvement upon those rectilinear power mechanisms known in the art. Thus, the invention discloses numerous advantages for bicyclists for whom speed, efficiency, reliability, and ergonomics are desired.

The invention can be used on an improved bicycle frame or a conventional bicycle frame. Because the invention does not utilize a conventional crank gear, the traditional “double-triangle” shape of a bicycle frame is not necessary. One improvement offered by the invention is that many frame elements in a double-triangle frame configuration such as a chain stay, seat tube, bottom bracket, and down tube can be eliminated and thereby allow a reduction in weight. The head tube, front fork, and steering mechanisms from conventional bicycle frames can be used, as the new propulsion mechanism does not affect the front wheel or steering of the bicycle.

Further, because light weight, efficiency, and ergonomics are desirable for all types of bicycles, this invention is adaptable for use on road bikes, racing bikes, mountain bikes, trail bikes or light-duty mountain bikes, comfort bikes, touring bikes, hybrid bikes, tandem bikes, BMX or dirt bikes, stationary exercise bicycles, juvenile and children's bikes, free-style bikes, jumping bikes, or any other type of bicycle known in the art. The invention is also adaptable to any of the many frame materials known in the art, including carbon-fiber, aluminum, chrome-moly, steel, titanium, and other materials known in the art.

In a preferred embodiment, the invention attaches to the bicycle frame at the base of the lowermost portion of the seat stay and serves to mount the rear hub and wheel of the bicycle and their associated parts, including: the rear wheel sprocket, the freewheel mechanism, the gears (if the bicycle uses gears), the pedals, and disk brake caliper, if the bicycle uses disk brakes. The invention is adaptable to bicycles using a conventional gear cassette, an internal gear hub, or any of the numerous gear configurations known in the art.

In this preferred embodiment of the invention, portions of the invention called the frame stems serve to attach the many parts of the bicycle propulsion mechanism and the rear wheel hub to the bicycle frame. Two frame stems either mount to each of the two forks of the seat stay or, alternatively, may be built as an integrated portion of the bicycle frame. The frame stems are manufactured from any of the many high-strength materials known in the art for mounting the rear hub and crank levers and in a variety of shapes for different bicycle types. The frame stems include many attachment points for the many parts which it attaches.

The lowermost portion of the frame stems attach the rear wheel hub of the bicycle. The frame stems may be configured to use fixed mounting or quick-release mounting mechanisms which are known in the art. The bicycle hub typically attaches the rear wheel, wheel bearings, the rear wheel sprocket, the freewheel mechanism, the gears, if the bicycle uses gears, the brake disk, if the bicycle uses disk brakes, and many other parts. Thus, in mounting the rear wheel hub, all of these parts are attached to the bicycle frame by the frame stems.

The frame stems also rotatably mount the crank levers. The crank levers are two levers pivoted at the frame stems and extending forward to the area beneath the seat where the bottom bracket is located in conventional bicycles. The crank levers mount the bicycle's pedals and are configured to locate the pedals in a position that is comfortable for the rider and ergonomically efficient for rectilinear reciprocation of the pedals. The propulsion mechanism is configured such that the crank levers move in opposite directions. That is, while one is moving down, the other is moving up. When the bicycle is in motion, the crank levers will transmit the force from the rider's leg and vertically reciprocate in a generally rectilinear pattern. (To be exact, the crank levers translate in an arc shape. Because, however, the length of the crank is long relative to the amount of vertical translation, this shape is approximately rectilinear). The crank levers are manufactured from any of the high strength materials known in the art, which are suitable for transmitting force, and can include one or more bends in their shape to improve ergonomics or efficiency. The crank levers mount any of the many pedal types known in the art.

The frame stems also rotatably mount the guide levers. The guide levers are two relatively short and relatively light levers that connect, either directly or via a pitman arm, the crank levers, at one of their midpoints, to the frame stems. The size, shape, and mounting position of the guide levers is configured such that the crank levers are kept in constant motion. That is, before one of the crank levers reaches its lowermost position, the opposite guide lever operates to change the direction of the opposite crank lever so that it begins moving downwards. In this manner, the guide levers operate to maintain the crank levers moving in opposite directions and maintain at least one crank lever constantly moving in the downwards direction.

Another component of the propulsion mechanism mounted by the frame stems is the drive assembly. The drive assembly is mounted at the base of the frame stems co-axially with the rear wheel hub and serves and the mounting point for the rear wheel hub. The drive assembly mounts to the frame stems via a bearing mechanism, which allows the drive assembly to rotate. The outermost portions of the drive assembly are two drive wheels that are connected to one another by a drive axel, located at the center axis of the wheel.

The drive wheels mount a drive arm, which serves to connect the drive wheels to the crank lever and transmit the force from the crank lever to the drive wheel. The drive arm attaches to the drive wheel at a point along the circumference of the drive wheel. Thus, as the drive arm is pushed by the crank lever, the drive wheel is torqued by the drive arm. The two drive wheels mount their respective drive arms at 180 degrees to one another. The drive arms, thus, always move in opposite directions to one another.

The drive wheels also attach to the gearbox drive, freewheel mechanism, or rear sprocket by a threaded connection or any of the other means known in the art. Thus, as the drive wheel is rotated by the drive arm, it applies force to the gearbox drive, freewheel mechanism, or rear sprocket and turns the rear wheel.

The drive arms are each rotatably connected to the crank lever and the drive wheel. Each serves to transmit the applied to the crank lever by the rider's leg to the drive wheel. Meanwhile, they also will apply the force from the drive wheel to the crank lever when the other crank lever is pushed down. The drive arms are manufactured from any of the high strength materials known in the art and configured to maintain a proper ergonomic position of the crank levers.

Thus, the components of the invention combine to form an efficient, reliable, and lightweight rectilinear reciprocating propulsion mechanism for bicycles.

As one crank lever of the mechanism is pushed down by the rider's leg, the force is transmitted via the drive arm to the drive wheel. This causes the drive wheel to rotate and, in turn, transmits the force to the gearbox, freewheel mechanism, or sprocket to bring the rear wheel into motion. Meanwhile, as the drive assembly rotates, the second drive wheel on the opposite side, is caused to rotate. As the second drive wheel rotates, the second drive arm pushes the second crank lever upwards. As the first crank lever approaches its lowermost position, the second guide lever changes the direction of the second crank lever so that it begins downwards motion. Thus, when the first crank reaches its lowermost point, the second crank is at its highest position and ready to be pushed downwards. At the same time, the first guide lever changes the direction of the first crank lever so that it begins to move upwards. Now, the rider pushes the second crank lever downwards and the cycle repeats itself in reverse. In this manner, reciprocating rectilinear motion of the crank levers is achieved by the invention.

It should be noted that, for purposes of conciseness, several peripheral aspects of the invention are not detailed in this discussion. A variety of materials, fasteners, accessories, and variations on the above configuration are available and within the contemplation of the invention. Also for conciseness, numerous variations on the invention, which make it more useable for specific types of bicycles and gear mechanisms are contemplated by the invention but not specifically disclosed.

### BRIEF DESCRIPTION OF THE DRAWINGS

FIG. 1 is an illustration in perspective view of a bicycle that uses one embodiment of the propulsion mechanism.

FIG. 2 is an illustration in close-up, perspective view of one embodiment of the propulsion mechanism.

FIG. 3 is an exploded view of one embodiment of the propulsion mechanism.

FIG. 4A through FIG. 4D illustrate the motion of one embodiment of the propulsion mechanism through one half-cycle of the cranks' motion.

FIG. 4A is an illustration in perspective view of the propulsion mechanism while the left crank is in its highest position.

FIG. 4B is an illustration in perspective view of the propulsion mechanism as the left crank begins to descend from its highest position.

FIG. 4C is an illustration in perspective view of the propulsion mechanism as the left crank approaches its lowermost position.

FIG. 4D is an illustration in perspective view of the propulsion mechanism while the left crank is in its lowermost position and the right crank is in its highest position.

FIG. 5A is an illustration in perspective view of the drive arm and related components of the propulsion mechanism.

FIG. 5B is an illustration in cross-sectional view of the drive arm and related components of the propulsion mechanism.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

In the following description, certain terminology is used to describe certain features of one or more embodiments of the invention. For instance, “bicycle” refers to any manually powered device, including exercise bicycles, consisting of a light frame mounted on wheels, and having a seat, handlebars for steering, brakes, and two pedals and “gear mechanism” refers to any of the external or internal gear hubs in single or multi-gear configurations, freewheel mechanisms, or other such mechanisms, used in propelling bicycles,

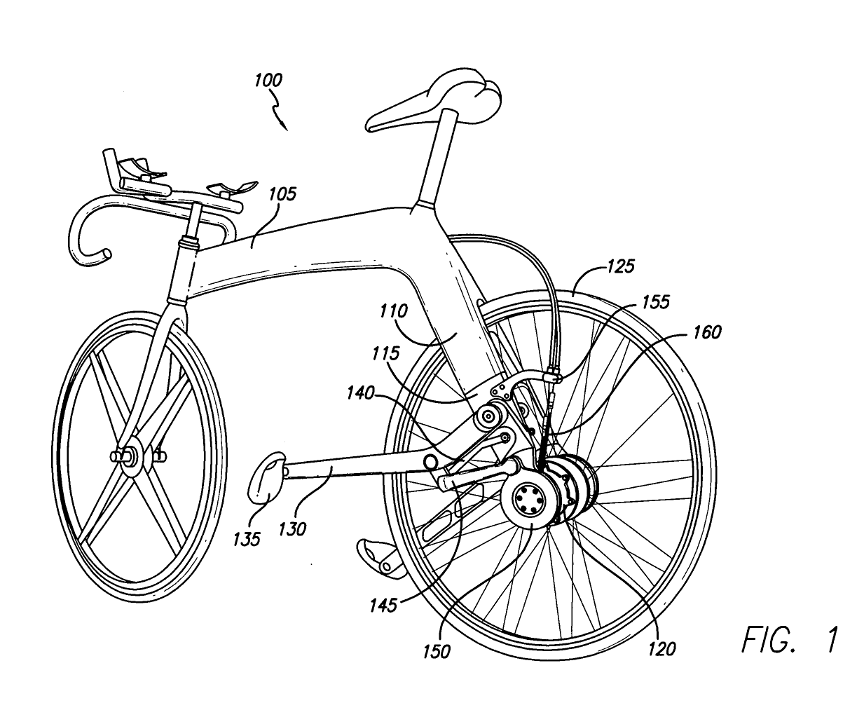

FIG. 1 is an illustration in perspective view of a bicycle 100 that uses one embodiment of the propulsion mechanism. A bicycle frame 105 is shown, which attaches the propulsion mechanism at the lowermost portion of the seat stays 110 of the bicycle frame 105. The frame stems 115 serves to mount the major components of the propulsion mechanism and the rear wheel hub 120 and rear wheel 125. The major components of the propulsion mechanism include the crank levers 130, which mount the pedals 135, the guide levers 140, the drive arms 145, and the drive wheels 150. The pedals 135 are configured to be located at approximately the location of the bottom bracket on conventional bicycles. On application of force to the pedals 135 by the rider, the crank levers 130 are depressed and transmit a force to the drive arms 145, which in turn, rotate the drive wheels 150. When the crank levers 130 approach their lowermost or highest position in the cycle, the guide levers 140 serve to change the direction of the crank levers. In this manner, the crank levers 130 are kept in constant motion. The motion of the pedals 135 is approximately rectilinear, as the length of the crank levers 130 is high relative to the distance which they displace vertically. This length allows the rider a great deal of leverage in applying force to the pedals 135. As the drive wheel 150 is rotated, it drives a gear mechanism, which, in turn, drives the rear wheel 125. The frame stems 155 can be used to mount accessories, such as a cable holder 155 for the gearing cables 160.

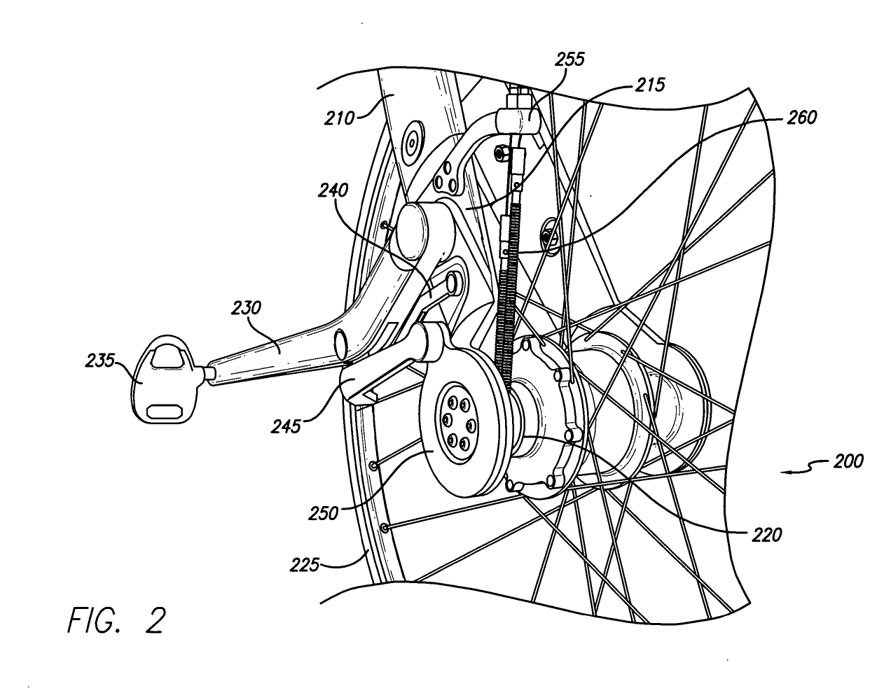

FIG. 2 is an illustration in close-up, perspective view of one embodiment of the propulsion mechanism. A propulsion mechanism is attached at the lowermost portion of the seat stays 210 of a bicycle frame. The frame stems 215 serve to mount the major components of the propulsion mechanism and the rear wheel hub 220 and rear wheel 225. In the illustrated embodiment, the rear wheel hub 220 mounts an internal gear mechanism. The invention, however, remains adaptable to any of the gearing mechanisms known within the art. The major components of the propulsion mechanism include the crank levers 230, which mount the pedals 235, the guide levers 240, the drive arms 245, and the drive wheels 250. On application of force to the pedals 235 by the rider, the crank levers 230 are depressed and transmit a force to the drive arms 245, which in turn, rotate the drive wheels 250. When the crank levers 230 approach their lowermost or highest position in the cycle, the guide levers 240 serve to change the direction of the crank levers. In this manner, the crank levers 230 are kept in constant motion. As the drive wheel 250 is rotated, it drives a gear mechanism, which, in turn, drives the rear wheel 225. The frame stems 255 may also be used to mount accessories, such as a cable holder 255 for the gearing cables 260.

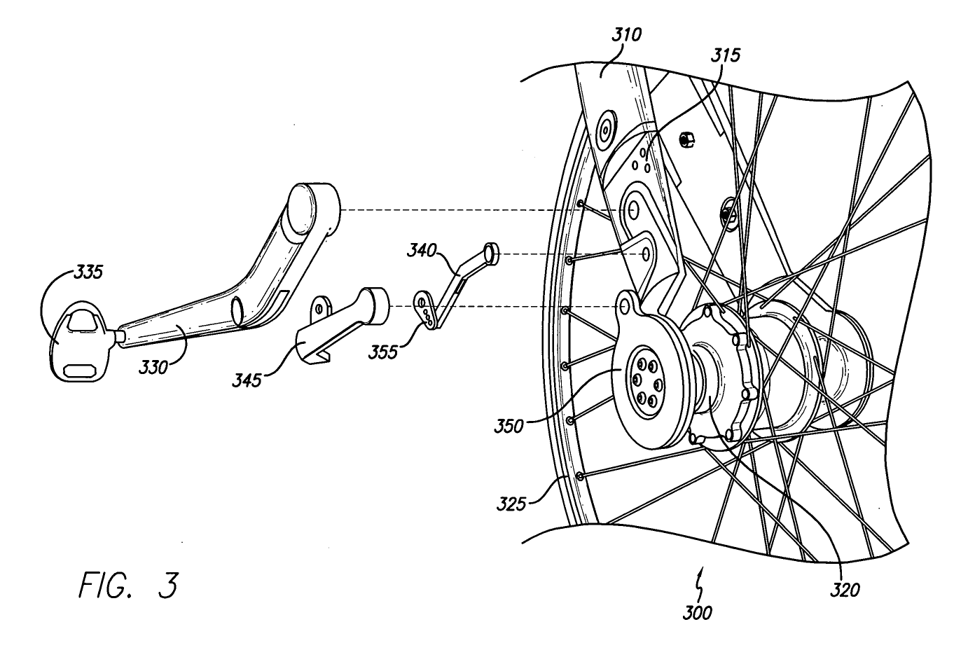

FIG. 3 is an exploded view of one embodiment of the propulsion mechanism. In this illustration, the many components of the propulsion mechanism are shown, including the frame stems 315, which mount to the bicycle frame at the lowermost portion of the seat stays 310, the rear wheel hub 320, the rear wheel 325, the crank levers 330, the pedals 335, the guide lever 340, the drive arm 345, the drive wheel 350, and the pitman arm 355. In this embodiment of the invention, the pitman arm 355 serves to attach the guide lever 340 to the crank levers 330. Also, by allowing adjustable attachment locations on the pitman arm 355, the motion of the crank levers 330 can be adjusted to suit the ergonomic needs of particular riders.

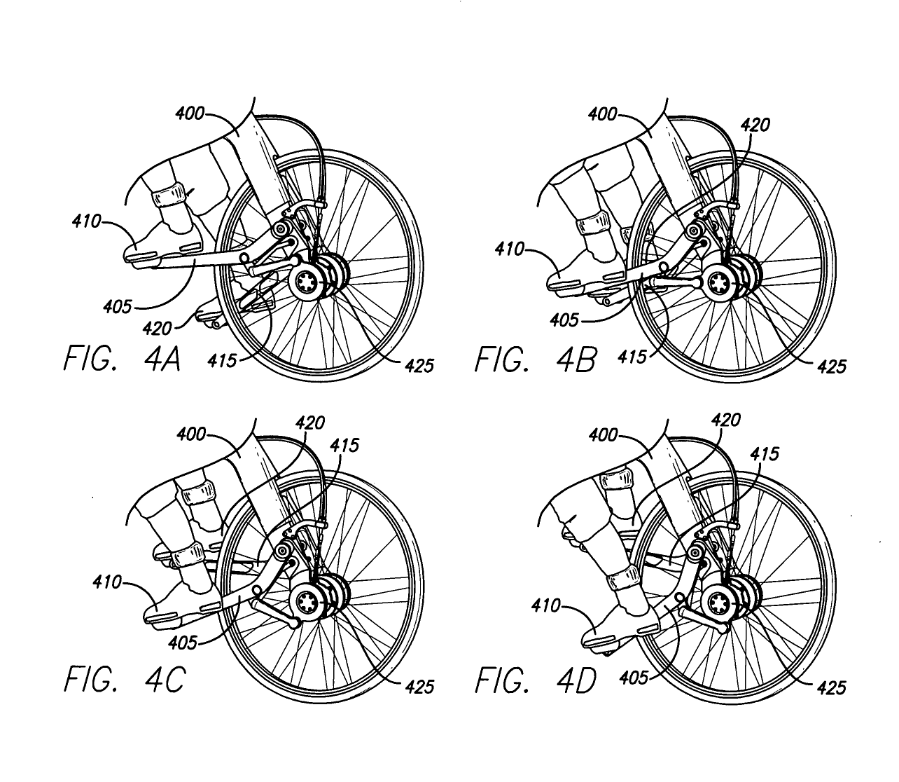

FIG. 4A through FIG. 4D illustrate the motion of one embodiment of the propulsion mechanism through one half-cycle of the cranks' motion. It should be noted that, unlike conventional bicycle drive mechanisms, throughout the crank levers' displacement cycle, they remain essentially perpendicular to the rider's tibia, allowing for greater torque to be transmitted to the crank levers. (This is because torque is at its greatest when the direction of force is perpendicular to the direction of the lever). What is more, because the propulsion mechanism utilizes longer crank levers than conventional bicycle drive mechanisms, the torque is further increased. (This is because torque is directly proportional to the length of the lever).

FIG. 4A is an illustration in perspective view of the propulsion mechanism while the left crank 405 is in its highest position. A bicycle frame 400 is shown, which mounts the propulsion mechanism. In this figure, the left crank 405 and the rider's left leg 410 are in their highest position. Meanwhile, the right crank 415 and rider's right leg 420 are in their lowermost position. It should be noted that the drive wheel 425 is at its starting position.

FIG. 4B is an illustration in perspective view of the propulsion mechanism as the left crank 405 begins to descent from its highest position. A bicycle frame 400 is shown, which mounts the propulsion mechanism. In this figure, the left crank 405 and the rider's left leg 410 begin their descent from their highest position. Meanwhile, the right crank 415 and rider's right leg 420 begin to rise from their lowermost position. As the crank levers move, the drive wheel 425 rotates and drives the rear wheel of the bicycle.

FIG. 4C is an illustration in perspective view of the propulsion mechanism as the left crank 405 approaches its lowermost position. A bicycle frame 400 is shown, which mounts the propulsion mechanism. In this figure, the left crank 405 and the rider's left leg 410 approach their lowermost position in the crank's cycle. Meanwhile, the right crank 415 and rider's right leg 420 rise towards their highest position in the cycle. As the crank levers move, the drive wheel 425 continues to rotate and drives the rear wheel of the bicycle.

FIG. 4D is an illustration in perspective view of the propulsion mechanism while the left crank 405 is in its lowermost position and the right crank is in its highest position. A bicycle frame 400 is shown, which mounts the propulsion mechanism. In this figure, the left crank 405 and the rider's left leg 410 are in their lowermost position. Immediately following this position, the left crank 405 begins to rise. Meanwhile, the right crank 415 and rider's right leg 420 are at their highest position. Following this position, the right crank 415 will begin to descend. It should be noted that, in this position, the drive wheel 425 has rotated 180 degrees relative to its position in FIG. 4A, when the cycle began.

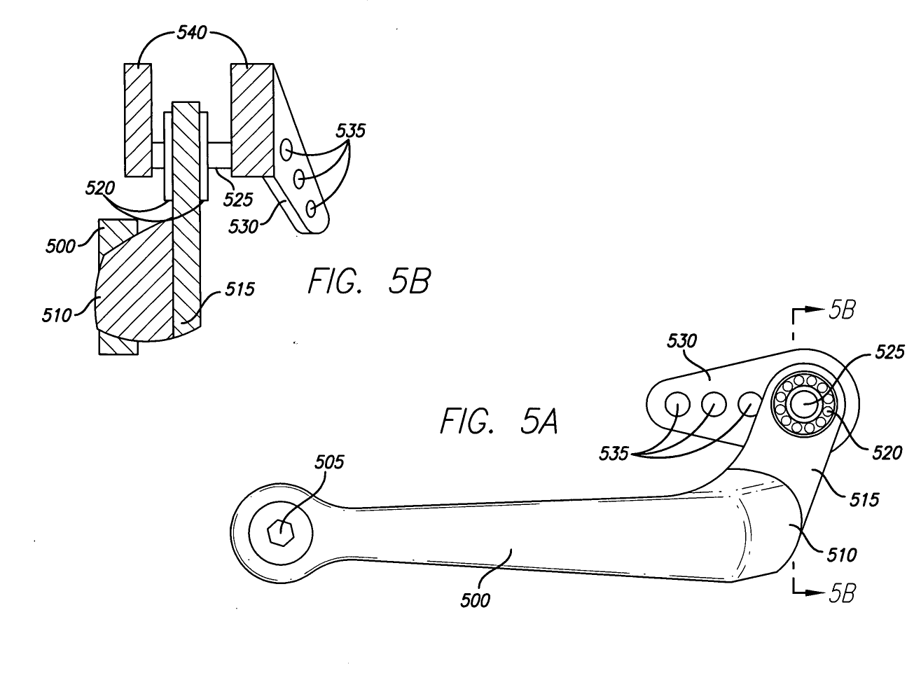

FIG. 5A is an illustration in perspective view of the drive arm and related components of the propulsion mechanism.

FIG. 5B is an illustration in cross-sectional view of the drive arm and related components of the propulsion mechanism.

I claim:

1. A bicycle propulsion mechanism, comprising,
a first half and a second half, each half including the following components:
a crank lever, said crank lever having a proximal end and a distal end,
said proximal end of said crank lever mounting a pedal,
said distal end of said crank lever being rotatably mounted to the bicycle frame,
a guide lever, said guide lever having a proximal end and a distal end,
said proximal end of said guide lever being rotatably mounted to a mid-point of said crank lever,
said distal end of said guide lever being rotatably mounted to the bicycle frame,
a drive arm, said drive arm having a proximal end and a distal end,
said proximal end of said drive arm being rotatably mounted to a mid-point of said crank lever,
said distal end of said drive arm being rotatably mounted to a point off-center on a drive wheel;
the drive wheel of the first half being fixedly connected to the drive wheel of the second half and the both drive wheels being rotatably connected to the bicycle frame,
one or both of said drive wheels being configured to transmit a torque to the rear wheel of the bicycle.

2. A bicycle propulsion mechanism, comprising,
a first half and a second half, each half including the following components:
a crank lever, said crank lever having a proximal end and a distal end,
said proximal end of said crank lever mounting a pedal,
said distal end of said crank lever being rotatably mounted to the bicycle frame,
a guide lever, said guide lever having a proximal end and a distal end,
said proximal end of said guide lever being rotatably mounted to a pitman arm,
said distal end of said guide lever being rotatably mounted to the bicycle frame,
said pitman arm having a proximal end and a distal end,
said proximal end of said pitman arm being rotatably connected to said crank lever,
said distal end of said pitman arm being rotatably connected to said guide lever,
a drive arm, said drive arm having a proximal end and a distal end,
said proximal end of said drive arm being rotatably mounted to a mid-point of said crank lever,
said distal end of said drive arm being rotatably mounted to a point off-center on a drive wheel;
the drive wheel of the first half being fixedly connected to the drive wheel of the second half and the both drive wheels being rotatably connected to the bicycle frame,
one or both of said drive wheels being configured to transmit a torque to the rear wheel of the bicycle.

3. A bicycle propulsion mechanism, comprising,
a first half and a second half, each half including the following components:
a frame stem, said frame stem having a proximal end and a distal end,
said proximal end of said frame stem fixedly attaching said frame stem to the bicycle frame,
said distal end of said frame stem rotatably attaching one or more drive wheels,
a crank lever, said crank lever having a proximal end and a distal end,
said proximal end of said crank lever mounting a pedal,
said distal end of said crank lever being rotatably mounted to said frame stem,
a guide lever, said guide lever having a proximal end and a distal end,
said proximal end of said guide lever being rotatably mounted to a pitman arm,
said distal end of said guide lever being rotatably mounted to said frame stem,
said pitman arm having a proximal end and a distal end,
said proximal end of said pitman arm being rotatably connected to said crank lever,
said distal end of said pitman arm being rotatably connected to said guide lever,
a drive arm, said drive arm having a proximal end and a distal end,
said proximal end of said drive arm being rotatably mounted to a mid-point of said crank lever,
said distal end of said drive arm being rotatably mounted to a point off-center on said drive wheel;
the drive wheel of the first half being fixedly connected to the drive wheel of the second half by an axel and the both drive wheels being rotatably connected to said frame stem,
one or both of said drive wheels being configured to transmit a torque to the rear wheel of the bicycle.

4. A bicycle propulsion mechanism according to claim 1, wherein said drive wheels transmit torque to the rear wheels by an internal gear hub.

5. A bicycle propulsion mechanism according to claim 2, wherein said drive wheels transmit torque to the rear wheels by an internal gear hub.

6. A bicycle propulsion mechanism according to claim 3, wherein said drive wheels transmit torque to the rear wheels by an internal gear hub.

7. A bicycle propulsion mechanism according to claim 1, wherein said drive wheels transmit torque to the rear wheels by an external gear hub.

8. A bicycle propulsion mechanism according to claim 2, wherein said drive wheels transmit torque to the rear wheels by an external gear hub.

9. A bicycle propulsion mechanism according to claim 3, wherein said drive wheels transmit torque to the rear wheels by an external gear hub.

10. A bicycle propulsion mechanism according to claim 1, wherein said drive wheels transmit torque to the rear wheels by a freewheel mechanism.

11. A bicycle propulsion mechanism according to claim 2, wherein said drive wheels transmit torque to the rear wheels by a freewheel mechanism.

12. A bicycle propulsion mechanism according to claim 3, wherein said drive wheels transmit torque to the rear wheels by a freewheel mechanism.

13. A bicycle propulsion mechanism according to claim 3, wherein one of the said frame stems mounts a disk caliper for disk brakes.

14. A bicycle propulsion mechanism according to claim 1, wherein said crank lever includes one or more bends in order to enhance the ergonomic performance of the propulsion mechanism.

15. A bicycle propulsion mechanism according to claim 2, wherein said crank lever includes one or more bends in order to enhance the ergonomic performance of the propulsion mechanism.

16. A bicycle propulsion mechanism according to claim 3, wherein said crank lever includes one or more bends in order to enhance the ergonomic performance of the propulsion mechanism.

17. A bicycle propulsion mechanism according to claim 1, wherein said drive arm includes a means for adjusting its mounting position to the crank lever.

18. A bicycle propulsion mechanism according to claim 2, wherein said pitman arm includes a means for adjusting its mounting position to the crank lever.

19. A bicycle propulsion mechanism according to claim 3, wherein said pitman arm includes a means for adjusting its mounting position to the crank lever.

20. A bicycle propulsion mechanism according to claim 1, wherein said propulsion mechanism is adapted for mounting to conventional bicycle frames.

21. A bicycle propulsion mechanism according to claim 2, wherein said propulsion mechanism is adapted for mounting to conventional bicycle frames.

22. A bicycle propulsion mechanism according to claim 3, wherein said propulsion mechanism is adapted for mounting to conventional bicycle frames.
